(19) United States
(12) Patent Application Publication
(10) Pub. No.: US 2026/0189805 A1
(43) Pub. Date: Jul. 2, 2026

(54) SUPPLEMENTAL FLAT FIELD CORRECTION DETERMINATION FOR INFRARED IMAGING SYSTEMS AND METHODS

(71) Applicant: Teledyne FLIR Commercial Systems, Inc., Goleta, CA (US)

(72) Inventor: Joseph Kostrzewa, Santa Ynez, CA (US)

(21) Appl. No.: 19/544,368

(22) Filed: Feb. 19, 2026

Related U.S. Application Data
(63) Continuation of application No. PCT/US2024/042876, filed on Aug. 19, 2024.
(60) Provisional application No. 63/578,560, filed on Aug. 24, 2023.

(51) Int. Cl. H04N 23/81; H04N 23/23; H04N 25/674

(52) U.S. Cl. CPC H04N 23/81; H04N 23/23; H04N 25/674

(57) ABSTRACT

Techniques are provided for facilitating supplemental flat field correction (SFFC) determination for infrared imaging systems and methods. In one example, a method includes capturing, by a focal plane array (FPA) of an imaging system, a first set of images of a first reference object in a scene while the first reference object is at a temperature associated with a second reference object when capturing the first set of images. The method further includes capturing, by the FPA, a second set of images of the second reference object. The method further includes determining SFFC values based on the first set of images and the second set of images. Related devices and systems are also provided.

### CROSS REFERENCE TO RELATED APPLICATIONS

This application is a continuation of International Patent Application No. PCT/US2024/042876 filed Aug. 19, 2024 and entitled “SUPPLEMENTAL FLAT FIELD CORRECTION DETERMINATION FOR INFRARED IMAGING SYSTEMS AND METHODS,” which claims priority to and the benefit of U.S. Provisional Patent Application No. 63/578,560 filed Aug. 24, 2023 and entitled “SUPPLEMENTAL FLAT FIELD CORRECTION DETERMINATION FOR INFRARED IMAGING SYSTEMS AND METHODS,” all of which are incorporated herein by reference in their entirety.

### TECHNICAL FIELD

One or more embodiments relate generally to imaging and more particularly, for example, to supplemental flat field correction (SFFC) determination for infrared imaging systems and methods.

### BACKGROUND

Imaging systems may include an array of detectors arranged in rows and columns, with each detector functioning as a pixel to produce a portion of a two-dimensional image. For example, an individual detector of the array of detectors captures an associated pixel value. There are a wide variety of image detectors, such as visible-light image detectors, infrared image detectors, or other types of image detectors that may be provided in an image detector array for capturing an image. As an example, a plurality of sensors may be provided in an image detector array to detect electromagnetic (EM) radiation at desired wavelengths. In some cases, such as for infrared imaging, readout of image data captured by the detectors may be performed in a time-multiplexed manner by a readout integrated circuit (ROIC). The image data that is read out may be communicated to other circuitry, such as for processing, storage, and/or display. In some cases, a combination of a detector array and an ROIC may be referred to as a focal plane array (FPA). Advances in process technology for FPAs and image processing have led to increased capabilities and sophistication of resulting imaging systems.

### SUMMARY

In one or more embodiments, a method includes capturing, by an FPA of an imaging system, a first set of images of a first reference object in a scene while the first reference object is at a temperature associated with a second reference object when capturing the first set of images. The method further includes capturing, by the FPA, a second set of images of the second reference object. The method further includes determining SFFC values based on the first set of images and the second set of images.

In one or more embodiments, an imaging system includes an FPA configured to capture a first set of images of a first reference object in a scene while the first reference object is at a temperature associated with a second reference object when capturing the first set of images. The FPA is further configured to capture a second set of images of the second reference object. The imaging system further includes a logic device configured to determine SFFC values based on the first set of images and the second set of images.

In one or more embodiments, a method includes capturing, by an FPA of an imaging system, a first set of images of a first reference object in a scene. The method further includes capturing, by the FPA, a second set of images of a second reference object while the second reference object is at a temperature associated with the FPA when capturing the second set of images. The method further includes determining SFFC values based on the first set of images and the second set of images.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an infrared camera in accordance with one or more embodiments of the present disclosure.

FIGS. 2 and 3 illustrate flow diagrams of example processes for determining SFFC values in accordance with one or more embodiments of the present disclosure.

FIG. 4 illustrates a flow diagram of an example process for applying SFFC values to captured image data in accordance with one or more embodiments of the present disclosure.

FIGS. 5 and 6 illustrate an example display screen with a dialog box displayed thereon for facilitating calibration of an infrared camera in accordance with one or more embodiments of the present disclosure.

FIG. 7 illustrates a block diagram of an example imaging system in accordance with one or more embodiments of the present disclosure.

FIG. 8 illustrates a block diagram of an example image sensor assembly in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Various techniques provide supplemental flat field correction determination for infrared imaging systems and methods. An imaging system may be used to capture image data associated with a scene using an image sensor device (e.g., a detector array of an FPA). The image sensor device includes detectors (e.g., also referred to as detector pixels, detector elements, or simply pixels). Each detector pixel may detect incident EM radiation and generate infrared image data indicative of the detected EM radiation of the scene. In some embodiments, the image sensor array is used to detect infrared radiation (e.g., thermal infrared radiation). For pixels of an infrared image (e.g., thermal infrared image), each output value of a pixel may be represented/provided as and/or correspond to a temperature, digital count value, percentage of a full temperature range, or generally any value that can be mapped to the temperature. For example, a digital count value of 13,000 output by a pixel may represent a temperature of 160° C. As such, the captured infrared image data may indicate or may be used to determine a temperature of objects, persons, and/or other features/aspects in the scene.

In some cases, an infrared imaging system (e.g., a thermal camera) may represent the infrared image data in an image according to a palette. The palette may provide a mapping from distinct output levels to visual representation values. The palette may be applied to image data values output by the image sensor device (e.g., based on detected EM radiation) of the infrared imaging system to generate the image. In this regard, an image may be considered a visual representation of the image data values. Visual representation values of a palette may include color values and/or grayscale values. In some cases, the visual representation values may facilitate analysis of the scene by a user(s) of the infrared imaging system and/or by circuitry (e.g., machine vision) of the infrared imaging system and/or other machine(s).

During a startup of (e.g., an initial power on of) the infrared imaging system or other internal heating process, the infrared imaging system is heated up internally. As one example, the startup may end after around five minutes (e.g., steady state begins around five minutes after startup is initiated). After the startup ends, temperatures and rates of change of temperature associated with various components of the infrared imaging system may generally be caused by external factors (e.g., temperature changes external to the infrared imaging system) rather than internal heating of the infrared imaging system. External temperatures may include ambient temperature and/or a temperature(s) of an object(s) in a scene. As an example of an internal heating process other than startup, an internal heating process may result from a change in operating mode of the infrared imaging system, such as a changing of a frame rate associated with an FPA which may cause a change in internal heating. As another example, an internal heating process may result from turning on/off or otherwise changing power dissipating electronics (e.g., those close to the FPA). For example, an internal heating process may result from changing image processing on a processor that is thermally coupled (e.g., closely thermally coupled) to the FPA.

In some embodiments, the infrared imaging system may be referred to as operating in a startup condition/mode (e.g., also referred to as a transient condition/mode) and a steady-state condition/mode (e.g., also referred to as an equilibrium condition/mode). An amount of time that the infrared imaging system spends operating in the startup mode and the steady-state mode may be based in part on an ambient temperature (e.g., a temperature of a room in which the infrared imaging system is situated). For example, the infrared imaging system may operate longer in the startup mode if it is turned on in a cold ambient temperature relative to being turned on in a warmer ambient temperature. During the startup condition, the infrared imaging system exhibits significant internal heating (e.g., due to powering on of various components of the infrared imaging system). To reach steady state condition, the infrared imaging system may be turned on and left on until the infrared imaging system exhibits steady state behavior. Once the infrared imaging system transitions from operating in the startup condition to operating in the steady state condition, the infrared imaging system exhibits steady-state behavior in which temperatures and/or temperature changes to one or more components of the infrared imaging system are primarily caused by external factors (e.g., temperature changes external to the infrared imaging system).

In some embodiments, the infrared imaging system (e.g., its FPA) may be calibrated through capture of images of one or more reference objects/sources and use of these captured images to determine SFFC values. A reference object may be, or may be considered, a thermal black body. The SFFC values associated with an FPA may be performed in digital imaging to remove artifacts from images captured by the FPA that are caused by variations in pixel-to-pixel output of the FPA (e.g., variations between individual detectors) and/or by distortions in an optical path. In some aspects, the infrared imaging system may include an internal reference object (e.g., also referred to as an internal structure) that may be used when determining SFFC values. In some cases, an internal reference object may refer to a reference object within a housing of the infrared imaging system. By way of non-limiting examples, an internal structure may include a shutter, a lid, a cover, or a paddle. For the calibration, the FPA of the infrared imaging system may capture a set of images (e.g., infrared images such as thermal infrared images) of a reference object in a scene (e.g., external scene) and/or a set of images of an internal reference object when the internal reference object is positioned over the FPA to block the FPA from the scene. By way of non-limiting examples, the external source/object may include a case or holster of the imaging system, a lens cap, a cover, a wall of a room, or other suitable object/surface.

The infrared imaging system may be recalibrated (e.g., run-time/in-the-field recalibration) as needed to maintain SFFC values that are up-to-date with the FPA's characteristics (e.g., variations in pixel-to-pixel output and/or distortions in an optical path) at the time of recalibration. In some cases, a user of the infrared imaging system may recalibrate the infrared imaging system when one or more components of the infrared imaging system is adjusted. By way of non-limiting examples, adjustments to the infrared imaging system may include an adjustment that changes the thermodynamics of the infrared imaging system in any appreciable way, such as if a thermal mass is strapped by the user to the shutter and/or a lens; an enclosure of the infrared imaging system is changed; an adjustment is made to an arrangement of one or more elements (e.g., optical elements); one or more elements are switched in or out; and so forth.

In some aspects, the infrared imaging system may include an audio device and/or a visual device (e.g., display, indicator light(s)) for providing audio feedback and/or visual feedback to suggest or otherwise facilitate a recalibration of the infrared imaging system. In some cases, the infrared imaging system may be coupled to a user device (e.g., via an app installed on the user device), such as a mobile device, a desktop, etc., having an audio device and/or a visual device for providing audio feedback and/or visual feedback. In some cases, the feedback may be triggered manually by the user (e.g., the user presses a button to initiate a calibration process) and/or autonomously by the infrared imaging system in response to, by way of non-limiting examples, an amount of time since a previous calibration exceeding a threshold time (e.g., set by the manufacturer or the user), a change in conditions (e.g., ambient temperature) in which the infrared imaging system is operating, and/or a change to the infrared imaging system's components (e.g., removing or adding a lens) and/or functionality parameters (e.g., changing a frame rate or a gain mode) by the user.

In some embodiments, to facilitate calibration/recalibration, user interfaces may be presented on a display device of, or otherwise coupled to, the infrared imaging system to provide guidance/instructions and/or data to the user. For example, the user interface may indicate a temperature of the FPA of the infrared imaging system and instruct the user to set a temperature of a reference object to the temperature of the FPA (e.g., for purposes of calibration/recalibration).

In some aspects, a calibration may be performed at the factory (e.g., as part of a manufacturing process prior to delivery to a customer) to determine an initial set of SFFC values associated with the FPA of the infrared imaging system and store the initial set of SFFC values in a memory of or otherwise accessible to the infrared imaging system. For example, the initial set of SFFC values may be associated a factory/default setup of the infrared imaging system. Run-time/in-the-field calibrations may be performed (e.g., by an operator of the infrared imaging system) to adjust/update or overwrite the initial set of SFFC values and/or previous set(s) of SFFC values determined during run-time/in-the-field calibrations. In some cases, the initial set of SFFC values and/or other set(s) of SFFC values may continue to be stored in the memory, such as to allow the user of the infrared imaging system to return to previous settings of the infrared imaging system. For example, the initial set of SFFC values may continue to be stored in the memory to allow the user of the infrared imaging system to return the infrared imaging system to factory settings (e.g., at least with respect to the SFFC values).

Although various embodiments are described primarily with respect to infrared imaging (e.g., thermal infrared imaging), methods and systems disclosed herein may be utilized in conjunction with devices and systems such as imaging systems having visible-light and infrared imaging capability, short-wave infrared (SWIR) imaging systems, light detection and ranging (LIDAR) imaging systems, radar detection and ranging (RADAR) imaging systems, millimeter wavelength (MMW) imaging systems, ultrasonic imaging systems, X-ray imaging systems, microscope systems, mobile digital cameras, video surveillance systems, video processing systems, or other systems or devices that may need to obtain image data in one or multiple portions of the EM spectrum.

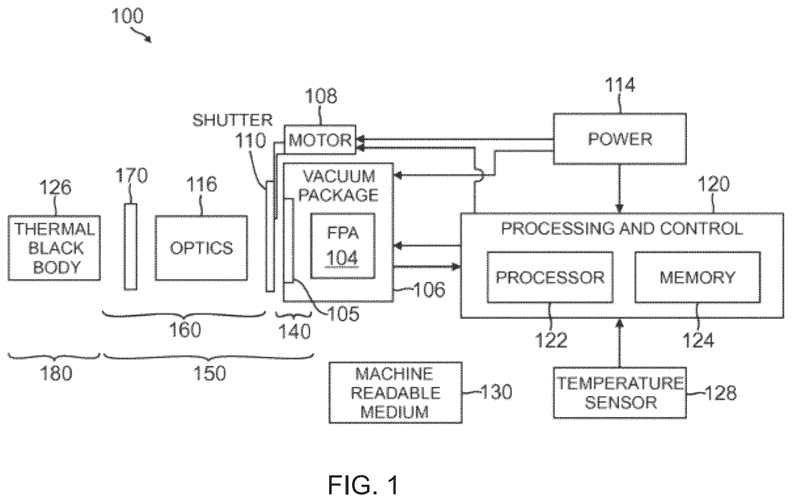

Referring now to the drawings, FIG. 1 illustrates an infrared camera 100 in accordance with one or more embodiments of the present disclosure. The infrared camera 100 includes an infrared detector package 106, a motor 108, a shutter 110, a power block 114, an optics block 116, a processing and control block 120, a temperature sensor(s) 128, and an optional window 170.

In one example, the infrared camera 100 may represent any type of infrared camera or thermal imaging system, is not limited to any specific embodiment disclosed herein, and may be implemented as desired for particular applications. Accordingly, in one embodiment, the components illustrated in FIG. 1 may be implemented as a standalone infrared camera. In another embodiment, the components of FIG. 1 may be distributed between a plurality of different devices. For example, the processing and control block 120 may be implemented by one or more external computer systems that interface with the infrared camera 100 (e.g., over a network or other appropriate communication medium). In another embodiment, the infrared camera 100 may be implemented with greater, fewer, and/or different components than those illustrated in FIG. 1 as appropriate for particular applications.

Infrared energy received from a scene 180 in front of the infrared camera 100 passes along an optical path 150 through the optics block 116 (e.g., optics including one or more elements for directing and/or focusing infrared radiation on the infrared detector package 106) to the infrared detector package 106 (e.g., a vacuum package assembly). In one embodiment, the infrared detector package 106 and the optics block 116 may be sealed inside a chamber (not shown) including the window 170 (e.g., a heated or temperature controlled protective window) positioned between the optics block 116 and the scene 180. The optics block 116 may include one or more windows, lenses, mirrors, beamsplitters, beam couplers, and/or other components. In this regard, the optics block 116 may include components each formed of material and appropriately arranged according to desired transmission characteristics, such as desired transmission wavelengths (e.g., at least the infrared wavelengths in FIG. 1) and/or ray transfer matrix characteristics.

The infrared detector package 106 includes an FPA 104 to detect infrared radiation passing through a window 105 (e.g., vacuum-package window) and provide thermal image data in response thereto. The FPA 104 includes a detector array and a readout circuit. The detector array may be implemented using various types of infrared detectors (e.g., quantum wells, microbolometers, or other types) as may be desired for particular implementations. The optics block 116 may receive electromagnetic radiation from the scene 180 and pass (e.g., direct and/or focus) the electromagnetic radiation to the FPA 104. In some cases, the optics block 116 may receive the electromagnetic radiation from the scene 180 through an aperture of the infrared camera 100. The FPA 104 may receive the electromagnetic radiation from the optics block 116 and generate image data based on the electromagnetic radiation (e.g., infrared component of the electromagnetic radiation).

The image data may include infrared data values (e.g., thermal infrared data values). As an example, the FPA 104 may include or may be coupled to an analog-to-digital converter (ADC) circuit that generates infrared data values based on infrared radiation. For example, a 16-bit ADC circuit may generate infrared data values that range from 0 to 65,535. The infrared data values may provide temperatures for different portions of the scene, such as provide temperatures of objects, persons, and/or other aspects in the scene 180. In some cases, the infrared image data may be represented in an image according to a palette, such that a visual representation value (e.g., color value or grayscale value) of each pixel of the image is indicative of a temperature associated with that pixel. For example, a temperature associated with an object in the scene 180 may be represented in pixels (e.g., a subset of pixels) of an infrared image (e.g., a thermal infrared image) that correspond to the object. The infrared image data may be displayed (e.g., to a user), stored, and/or processed.

In order to calibrate the FPA 104, a thermal black body 126 may be positioned in the scene 180 such that the thermal black body 126 subtends (e.g., covers, overlaps) a field of view (FOV) of the infrared camera 100. The thermal black body 126 may fully subtend the FOV of the infrared camera 100. In some cases, by operating the infrared camera 100 in a thermally stable environment (e.g., corresponding to a thermal steady state condition such as room temperature) and capturing thermal images of the thermal black body 126, FFC values may be determined which may be applied to thermal image data received from the FPA 104 to correct for non-uniformities (e.g., thermal loading or optical irregularities) present in the optical path 150. Alternative or additional steps may be performed to calibrate the FPA 104 as further described herein.

In some cases, a steady state condition of the infrared camera 100 may be reached after the infrared camera 100 has been powered on for a period of time, such as two minutes, three minutes, ten minutes, etc. In this regard, for example, a steady state temperature of a component may refer to a temperature at which the component does not exhibit any further self-heating or exhibits negligible further self-heating. Different components of the infrared camera 100 may be associated with different steady state temperatures. An infrared camera with higher thermal mass (e.g., infrared camera with larger elements such as larger lenses) may be associated with different steady state temperatures of the various components (e.g., lower average steady state temperatures). In some cases, in a power toggle situation in which the infrared camera 100 is turned off and turned back on soon thereafter, the infrared camera 100 can reach (e.g., return to) its associated steady state temperature(s) faster than in a case that the infrared camera 100 was turned off for a relatively long period of time (e.g., twenty minutes, an hour, or other amount of time to allow sufficient cooling of the infrared camera 100) and then turned back on.

The shutter 110 may be selectively inserted into the optical path 150 through the operation of the motor 108 to facilitate calibration of the FPA 104. For example, in the embodiment illustrated in FIG. 1, the shutter 110 is shown inserted into the optical path 150. While inserted into the optical path 150, the shutter 110 substantially blocks infrared radiation from passing to the FPA 104 from the scene 180. In this case, the FPA 104 instead detects infrared radiation received from the shutter 110 along an optical path 140, to the exclusion of infrared radiation received along an optical path 160. In one embodiment, the shutter 110 may be implemented to approximate a thermal black body in front of infrared detector package 106. By calibrating the FPA 104 to the shutter 110, FFC values may be determined which may be applied to infrared detectors of the FPA 104 in order to correct for non-uniformities present in the optical path 140 and also to correct for non-uniformities in the infrared detectors of the FPA 104 itself.

In some cases, one or more elements (e.g., lenses, mirrors, and/or other components) of the optics block 116 may be selectively inserted into the optical path 150. Accordingly, the infrared camera 100 may be operated with various focal lengths (e.g., 25 mm, 35 mm, 50 mm, 140 mm, or others) as may be desired for particular applications. The different types of optical configurations (e.g., elements, arrangements of elements, focal length of elements, etc.) may contribute to different non-uniformities in the propagation of infrared radiation along the optical path 150. In this regard, in some embodiments, a user of the infrared camera 100 may recalibrate the infrared camera 100 whenever an adjustment is made to the optics block 116, such as when one or more elements are removed from, added/inserted into, and/or repositioned in the infrared camera 100. In some aspects, such recalibration may be performed to determine SFFC values associated with the optics block 116 after an adjustment(s) is made. In one case, the infrared camera 100 may provide audio feedback and/or visual feedback via an audio device (e.g., beeper, speaker) or visual device (e.g., display, indicator light(s)) of the infrared camera 100 or otherwise communicatively coupled to the infrared camera 100 to perform a recalibration. Such feedback may be triggered manually by the user (e.g., the user presses a button to initiate a calibration process) and/or autonomously by the infrared camera 100 in response to detection of a change in the optics block 116 by the infrared camera 100.

The power block 114 may include a circuit board power subsystem (e.g., a power board) for the infrared camera 100. For example, the power block 114 may provide various power conversion operations and desired power supply voltages, power on-off switching (e.g., also referred to as turn on-off switching), and various other operations (e.g., a shutter driver for the motor 108), including an interface to a battery or external power supply, as would be understood by one skilled in the art.

The processing and control block 120 includes a processor 122 and a memory 124. The processor 122 may be configured with appropriate software (e.g., one or more computer programs for execution by the processor 122) stored on a machine readable medium 130 (e.g., a CD-ROM or other appropriate medium) and/or in the memory 124 to instruct the processor 122 to perform one or more of the operations described herein. The processor 122 and the memory 124 may be implemented in accordance with any desired combination of one or more processors and/or one or more memories as desired for particular implementations.

The processing and control block 120 may receive thermal image data captured by infrared detectors of the FPA 104 and processes the thermal image data to perform a flat field correction on the data to account for non-uniformities associated with the infrared detectors of the FPA 104 and other non-uniformities associated with other portions of the optical path 150 (e.g., non-uniformities associated with the optics block 116 and/or other portions of the infrared camera 100). The corrected thermal image data may be used to provide corrected thermal images which account for aberrations in the optical path 150.

The processing and control block 120 may also interface with the motor 108 to control the insertion and removal of the shutter 110 from the optical path 150. Advantageously, the processing and control block 120 may receive thermal image data captured by the FPA 104 either while the shutter 110 is inserted into the optical path 150 or while the shutter 110 is removed from the optical path 150. The shutter 110 may be used to provide/present a uniform scene to the detectors of the FPA 104. When the shutter 110 is inserted in the optical path 150, the detectors of the FPA 104 are effectively blinded from the scene 180. As a result, the processing and control block 120 may selectively calibrate the FPA 104 along either the optical path 140 (e.g., while the shutter 110 is inserted in the optical path 150) or the optical path 150 (e.g., while the shutter 110 is removed from the optical path 150). For example, in one embodiment, the processing and control block 120 may determine flat field correction values (e.g., gain and offset values) associated with individual infrared detectors of the FPA 104 to correct for non-uniformities associated with the infrared detectors for either the optical path 140 or the optical path 150. The flat field correction values may be further processed to determine supplemental FFC values to correct for non-uniformities associated with the optical path 160.

In some embodiments, the processing and control block 120 may perform operations such as non-uniformity correction (NUC) (e.g., FFC or other calibration technique), spatial and/or temporal filtering, and/or radiometric conversion on pixel values. As an example, an FFC calibration process (e.g., also referred to as an FFC event) may generally refer to a calibration technique performed in digital imaging to remove artifacts from frames that are caused by variations in pixel-to-pixel output of the FPA 104 (e.g., variations between individual detectors of the FPA 104) and/or by distortions in an optical path.

The processing and control block 120 may also interface with the temperature sensor(s) 128 to determine a temperature and a rate of temperature change of the ambient environment in which the infrared camera 100 is positioned and/or one or more components of the infrared camera 100 (e.g., FPA 104, infrared detector package 106, motor 108, shutter 110, power block 114, optics block 116, processing and control block 120, window 170, and/or other components). The processing and control block 120 may be configured to scale the supplemental FFC values based, in some cases, on temperature readings obtained from the temperature sensor(s) 128.

The temperature sensor(s) 128 may be positioned in any desired location of the infrared camera 100 (e.g., optics block 116, FPA 104, mechanical components near the optical path 150 such as the shutter 110 and/or the window 170, and/or other locations of the infrared camera 100) and/or in the ambient environment in which the infrared camera 100 is positioned. For example, in one embodiment, one or more of the temperature sensor(s) 128 is positioned on a housing of the infrared camera 100, the FPA 104, the window 105, the window 170, and/or the shutter 110 (e.g., shutter paddle). In this regard, the temperature sensor(s) 128 may be positioned to appropriately measure and provide temperature readings of various internal components of the infrared camera 100, components external to and/or externally coupled to the infrared camera 100, ambient environment, and so forth. Each temperature sensor may be a thermistor, thermocouple, and/or other thermal sensor for measuring temperature. As one example, the infrared camera 100 may be a small camera module that includes a single temperature sensor used to measure a temperature of the FPA 104. As another example, the infrared camera 100 may include a temperature sensor to measure the temperature of the FPA 104 and a temperature sensor to measure a temperature of a lens of the optics block 116.

As such, for some of these components, a temperature of the components may be measured directly using one or more of the temperature sensor(s) 128. Other components may not have a temperature sensor for measuring their temperatures. In some cases, a temperature of one or more of these other components may be determined (e.g., estimated, modeled) based in part on temperature data (e.g., temperature measurements) from the temperature sensor(s) 128. For example, a temperature sensor may be disposed on the FPA 104 to measure a temperature of the FPA 104 whereas no temperature sensor is disposed on the shutter 110. Due to proximity between the shutter 110 and the FPA 104 in the infrared camera 100, a temperature of the shutter 110 may be determined based on the measured temperature of the FPA 104. In some cases, a temperature sensor(s) may not be disposed on each component itself due to spatial considerations (e.g., limited space around the component and/or within the housing, disposing of a temperature sensor on the component may block an optical path to the FPA 104, etc.), power considerations (e.g., each disposed temperature sensor requires power to operate), and/or other considerations (e.g., device costs, maintenance and/or recalibration, etc.).

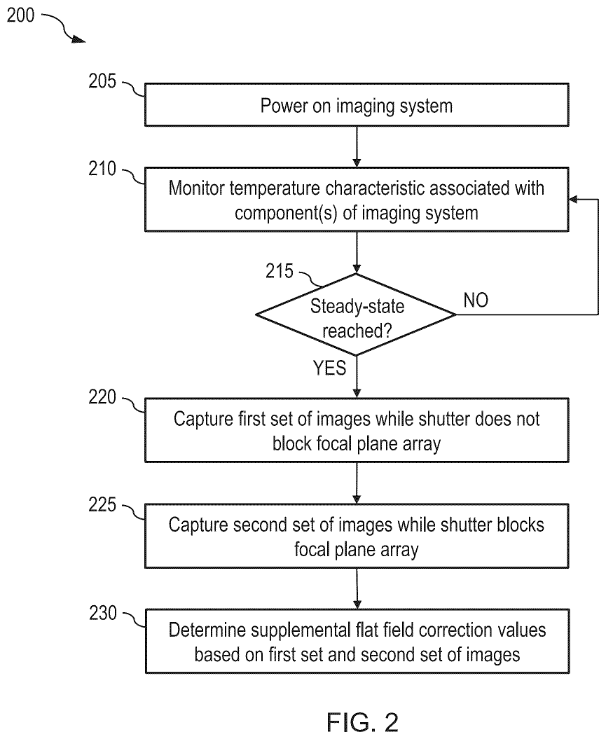

FIG. 2 illustrates a flow diagram of an example process 200 for determining SFFC values (e.g., an SFFC map) in accordance with one or more embodiments of the present disclosure. Although the process 200 is primarily described herein with reference to the infrared camera 100 of FIG. 1 for explanatory purposes, the process 200 can be performed in relation to other systems for determining SFFC values. Note that one or more operations in FIG. 2 may be combined, omitted, and/or performed in a different order as desired.

In one example, the process 200 of FIG. 2 may be performed by a provider of the infrared camera 100 (e.g., a manufacturer, designer, and/or other party utilizing the infrared camera 100). In this example, SFFC values may be generated by the provider and stored by the infrared camera 100 to be subsequently used during operation of the infrared camera 100 by a user. In another example, alternatively or in addition to performance of the process 200 by the provider, the process 200 of FIG. 2 may be performed by a user of the infrared camera 100. In this example, the user may perform calibration, such as in-the-field calibration, to generate SFFC values. Such SFFC values may be considered updated SFFC values relative to the SFFC values generated by the provider. In yet another example, performance of the process 200 of FIG. 2 may be distributed between a provider of the infrared camera 100 and a user of the infrared camera 100.

At block 205, the infrared camera 100 is powered on. At block 210, the temperature sensor(s) 128 monitors a temperature characteristic associated with one or more components of the infrared camera 100. By way of non-limiting examples, the component(s) may include the FPA 104, the processor 122, the memory 124, the motor 108, the shutter 110, the optics block 116 (e.g., one or more optical components of the optics block 116), the window 170, a lens barrel, a housing/enclosure, and/or other components of the infrared camera 100. The temperature characteristic associated with a component may include a temperature associated with a component and/or a rate of change of the temperature associated with the component. At block 215, the processor 122 determines whether the infrared camera 100 has reached steady state based on the monitored temperature characteristic. In an aspect, at block 210, the temperature sensor(s) 128 may monitor a rate of change of a temperature associated with the FPA 104 (e.g., denotable as dT_{FPA}/dt) and, at block 215, the processor 122 may determine whether the infrared camera 100 has reached steady state based on the rate of change of the temperature associated with the FPA 104. More generally, as different components of the infrared camera 100 may reach steady state at different times and different temperatures, the processor 122 may determine at block 215 whether one or more components of the infrared camera 100 associated with SFFC map determination has reached steady state. For explanatory purposes in relation to the process 200, the infrared camera 100 is determined/considered to have reached steady state when the FPA 104 is determined to have reached steady state.

If the processor 122 determines at block 215 that the infrared camera 100 has not reached steady state, the process 200 proceeds from block 215 back to block 210 to continue monitoring the temperature characteristic associated with the component(s) (e.g., the FPA 104) of the infrared camera 100.

If the processor 122 determines at block 215 that the infrared camera 100 has reached steady state, the process 200 proceeds from block 215 to block 220. In this regard, when steady state has been reached, the component(s) of the infrared camera 100, such as the FPA 104 and the shutter 110, among others, are at and remains around their respective steady-state temperature. At block 220, the FPA 104 captures a first set of images while the shutter 110 does not block the FPA 104 and an FOV associated with the infrared camera 100 (e.g., an FOV of the optics block 116) is subtended (e.g., covered, overlapped) by a reference object in the scene 180 (e.g., also referred to as scene external to the infrared camera 100 or external scene). The FOV associated with the infrared camera 100 may be fully subtended by the reference object. In FIG. 1, the reference object may be the thermal black body 126. The first set of images may include a single image or multiple images (e.g., a sequence of images). In this regard, the FPA 104 may capture an image(s) of the reference object external to the infrared camera 100 by receiving electromagnetic radiation (e.g., infrared radiation) associated with the reference object received via the optical path 150 and generating the image(s) based on the electromagnetic radiation. In some cases, any electromagnetic radiation detected by the FPA 104 may include non-uniformities associated with the shutter 110, infrared detectors of the FPA 104, the optics block 116, and/or other components of the infrared camera 100 that may contribute electromagnetic radiation along the optical path 150. During block 220, the processing and control block 120 may control the motor 108 such that the shutter 110 does not block the optical path 150. In an aspect, the reference object may be referred to as an external thermal black body or simply an external black body and block 220 may be referred to as, or as part of, an external FFC process.

In an embodiment, the reference object (e.g., the thermal black body 126) is at approximately the same temperature as a steady-state temperature of the shutter 110 at the time the first set of images of the reference object are captured by the FPA 104. For example, if the shutter 110 is at 30° C. when block 220 is performed (e.g., the shutter 110 has a steady-state temperature of 30° C.), the reference object is set to 30° C. to track the temperature of the shutter 110. In an aspect, the temperature sensor 128 may measure a temperature of the shutter 110. In another aspect, the temperature sensor 128 may measure a temperature of one or more components of the infrared camera 100 relatively close to the shutter 110, and the processor 122 may determine (e.g., estimate) the temperature of the shutter 110 based on the measured temperature of the component(s). As such, in some cases, a temperature associated with the shutter 110 may be based on a direct temperature measurement(s) of the shutter 110. In some cases, a temperature measurement(s) of one or more components relatively close to the shutter 110, such as the FPA 104 or a lens of the optics block 116 in some configurations, may be used as the temperature of the shutter 110 or used to derive (e.g., using a relationship) the temperature of the shutter 110. In some cases, a relationship (e.g., an equation, a lookup table, etc.) between the temperature of the shutter 110 and the temperature of one or more components relatively close to the shutter 110 may be determined during calibration of the infrared camera 100. In various implementations, the temperature sensor 128 monitors the temperature of the FPA 104 and the FPA 104 is close to the shutter 110 (e.g., and thus can be considered to be at the same or similar temperature as the shutter 110). In such implementations, the temperature associated with the shutter 110 may be, or may be derived from, the temperature of the FPA 104 due to the proximity between the shutter 110 and the FPA 104.

At block 225, the FPA 104 captures a second set of images while the shutter 110 is positioned to block the FPA 104 and the FOV associated with the infrared camera 100 continues to be subtended (e.g., fully subtended) by the reference object. In an embodiment, the reference object is at approximately the same temperature as the shutter 110 at the time the second set of images are captured by the FPA 104. In this regard, since the infrared camera 100 continues to be in steady state, the temperature of the reference object and the shutter 110 are at approximately the steady-state temperature of the shutter 110. The second set of images may include a single image or multiple images (e.g., a sequence of images). In this regard, the FPA 104 may capture an image(s) of the shutter 110 by receiving electromagnetic radiation via the optical path 140 and generating the image(s) based on the electromagnetic radiation. In some cases, any electromagnetic radiation detected by the FPA 104 may include non-uniformities associated with the shutter 110, infrared detectors of the FPA 104, and/or other components of the infrared camera 100 that may contribute electromagnetic radiation along the optical path 140. During block 225, the processing and control block 120 may control the motor 108 to position the shutter 110 in the optical path 150 such that the FPA 104 captures images along the optical path 140. In an aspect, the shutter 110 may be referred to as an internal thermal black body or simply an internal black body and block 225 may be referred to as, or as part of, an internal FFC process. It is noted that, in some cases, block 225 may be performed before or after block 220.

At block 230, the processor 122 determines SFFC values based on the first set of images and the second set of images. The SFFC values may be stored (e.g., in the memory 124 and/or other memory of and/or accessible to the infrared camera 100) and/or further processed. The SFFC values may be provided as (e.g., stored as) an SFFC map. In this regard, an SFFC map be a data structure that includes the SFFC values. The SFFC values/map may be applied to images. In some aspects, the SFFC values may be based on a difference between the first and second set of images. When the first set of images and/or the second set of images includes multiple images, the processor 122 may determine an average of a set of images to obtain an average image. For a given set of images, a value of each pixel of the average image may be obtained by averaging over values of the same pixel in the set of images. For example, when the first set of images and the second set of images include a first sequence of images and a second sequence of images, respectively, the processor 122 may determine a temporal average of the first sequence and a temporal average of the second sequence and subtract the temporal average of the second sequence from the temporal average of the first sequence to obtain the difference between the first and second set of images. In some cases, when determining an average image, one or more pixel values of one or more images of the sequence may be ignored when the pixel value(s) is considered an outlier (e.g., falls outside a range of values) when compared to the same pixels of the other images.

In an aspect, the first set of images or an average thereof may be, may be indicative of (e.g., used to derive), and/or may be considered FFC values associated with the optical path 150 (e.g., from the external scene 180 to the FPA 104) whereas the second set of images or an average thereof may be, may be indicative of, and/or may be considered FFC values associated with the optical path 140 (e.g., from the shutter 110 to the FPA 104). As such, the difference between the first set of images and the second set of images (e.g., the difference between their averages) may be, may be indicative of (e.g., used to derive), and/or may be considered a difference between the FFC values associated with the optical path 140 and the FFC values associated with the optical path 150. In an aspect, the difference between the first and second set of images is, or is indicative of, a difference between a nearly-zero out-of-field irradiance condition and a steady-state out-of-field irradiance condition.

In some embodiments, the external FFC operation and capturing of the first set of images and the second set of images while a reference object (e.g., a thermal black body) is at or at approximately the same temperature as the shutter 110 when the respective set of images are captured allows for minimizing (e.g., reducing or avoiding) an in-field signal/component (e.g., an influence of an in-field signal/component) on the SFFC values (e.g., by essentially removing a pedestal caused by an in-field signal/component) at steady state compared to conventional approaches in which external FFCs and internal FFCs are performed while an FOV of a camera is covered by a black body having a room-ambient temperature. In this regard, in some aspects, the SFFC values determined according to various embodiments herein may be associated with reduced radiometric error (e.g., via a reduced or eliminated in-field signal) relative to SFFC values determined if the first and/or second set of images are captured by the FPA 104 while the reference object that subtends the infrared camera 100 is at a room ambient temperature. As such, the SFFC values determined according to various embodiments herein may be a closer representation of exclusively an out-of-field signal/component at steady state (e.g., substantially devoid of any in-field signal/component) compared to conventional approaches.

Although the process 200 of FIG. 2 for determining SFFC values involves use of the shutter 110 as a black body (e.g., when performing an internal FFC), in some embodiments SFFC values may be determined without use of a shutter or other internal black body. Such embodiments may be performed, for example, when an infrared imaging system has no shutter or has a non-functioning shutter and/or when a provider or a user does not want to use the shutter for determining SFFC values.

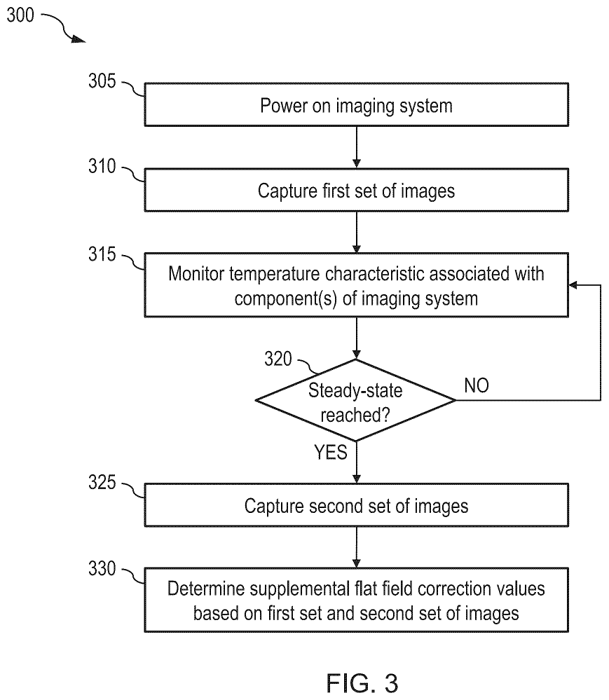

FIG. 3 illustrates a flow diagram of an example process 300 for determining SFFC values (e.g., an SFFC map) without using an internal black body in accordance with one or more embodiments of the present disclosure. Although the process 300 is primarily described herein with reference to the infrared camera 100 of FIG. 1 for explanatory purposes without using the shutter 110 depicted in FIG. 1, the process 300 can be performed in relation to other systems for determining SFFC values. Note that one or more operations in FIG. 3 may be combined, omitted, and/or performed in a different order as desired.

In one example, the process 300 of FIG. 3 may be performed by a provider of the infrared camera 100 (e.g., a manufacturer, designer, and/or other party utilizing the infrared camera 100). In this example, SFFC values may be generated by the provider and stored by the infrared camera 100 to be subsequently used during operation of the infrared camera 100 by a user. In another example, alternatively or in addition to performance of the process 300 by the provider, the process 300 of FIG. 3 may be performed by a user of the infrared camera 100. In this example, the user may perform calibration, such as in-the-field calibration, to generate SFFC values. Such SFFC values may be considered updated SFFC values relative to the SFFC values generated by the provider. In yet another example, performance of the process 300 of FIG. 3 may be distributed between a provider of the infrared camera 100 and a user of the infrared camera 100.

At block 305, the infrared camera 100 is powered on. At block 310, the FPA 104 captures a first set of images while an FOV associated with the infrared camera 100 (e.g., an FOV of the optics block 116) is subtended (e.g., fully subtended) by a reference object (e.g., the thermal black body 126) in the scene 180. The first set of images may include a single image or multiple images (e.g., a sequence of images). In this regard, the FPA 104 may capture an image(s) of the reference object external to the infrared camera 100 by receiving electromagnetic radiation (e.g., infrared radiation) associated with the reference object received via the optical path 150 and generating the image(s) based on the electromagnetic radiation.

The FPA 104 may be used to capture the first set of images immediately (e.g., as soon as possible) after the infrared camera 100 is powered on. For example, as soon as the FPA 104 and any other components that facilitate or are otherwise required to be powered on to capture images, the FPA 104 may be used to capture the first set of images. In general, at an initial startup of the infrared camera 100, the FPA 104 is at or around room-ambient temperature (e.g., also referred to as room temperature or ambient temperature). In this regard, the FPA 104 is at around the temperature of an environment (e.g., a room) within which the infrared camera 100 resides. As an example, a room-ambient temperature may be between 18° C. and 26° C. In some cases, when powering up, the FPA 104 may self heat by around 10° C. or 15° C. to reach a steady-state temperature. In such cases, the FPA 104 may self heat from its initial room temperature of around 22° C. to a steady-state temperature of between around 32° C. and around 37° C.. In some cases, the infrared camera 100 may be in normal operation (e.g., for capturing images not used for calibration purposes) before transitioning to calibration operation to perform the process 300. In some cases, before performing block 305 of the process 300, the infrared camera 100 may have been off for a sufficient amount of time to allow the FPA 104 to be at around the room ambient temperature.

In an embodiment, the reference object (e.g., the thermal black body 126) is at a room-ambient temperature and, as such, may be referred to as a room-ambient thermal black body. In this regard, at block 310, the reference object and the FPA 104 are both at around room temperature. In some cases, the temperature of the reference object is not controlled and the reference object is at room temperature due to being present in an environment (e.g., a room) that is at room temperature. In other cases, the temperature of the reference object is controlled (e.g., with an appropriate heating element(s) and/or cooling element(s)) to set the reference object to room temperature.

At block 315, the temperature sensor(s) 128 monitors a temperature characteristic associated with one or more components of the infrared camera 100. The temperature characteristic associated with a component may include a temperature associated with a component and/or a rate of change of the temperature associated with the component. At block 320, the processor 122 determines whether the infrared camera 100 has reached steady state based on the monitored temperature characteristic. In an aspect, at block 315, the temperature sensor(s) 128 may monitor a rate of change of a temperature associated with the FPA 104 (e.g., denotable as dT_{FPA}/dt) and, at block 320, the processor 122 may determine whether the infrared camera 100 has reached steady state based on the rate of change of the temperature associated with the FPA 104. As different components of the infrared camera 100 may reach steady state at different times and different temperatures, the processor 122 may determine at block 320 whether one or more components of the infrared camera 100 associated with SFFC map determination has reached steady state. For explanatory purposes in relation to the process 300, the infrared camera 100 is considered to have reached steady state when the FPA 104 is determined to have reached steady state.

If the processor 122 determines at block 320 that the infrared camera 100 has not reached steady state, the process 300 proceeds from block 320 back to block 315 to continue monitoring the temperature characteristic associated with the component(s) (e.g., the FPA 104) of the infrared camera 100.

If the processor 122 determines at block 320 that the infrared camera 100 has reached steady state, the process 300 proceeds from block 320 to block 325. In this regard, when steady state has been reached, the component(s) of the infrared camera 100, such as the FPA 104, among others, are at and remains around their respective steady-state temperature. At block 325, the FPA 104 captures a second set of images while the FOV associated with the infrared camera 100 is subtended (e.g., fully subtended) by a reference object at approximately the same temperature as the FPA 104 at the time the second set of images are captured. The second set of images may include a single image or multiple images (e.g., a sequence of images). In this regard, the FPA 104 may capture an image(s) of the thermal black body by receiving electromagnetic radiation via the optical path 150 and generating the image(s) based on the electromagnetic radiation.

In some aspects, the reference object used at block 325 is the same as the reference object used at block 310. When the same reference object is used at blocks 310 and 325, the reference object may be heated to track heating (e.g., self heating) of the FPA 104 such that a temperature change of the FPA 104 between blocks 310 and 325 (e.g., the FPA 104 heats up from a room-ambient temperature to a steady-state temperature) is the same or around the same as a temperature change of the reference object between blocks 310 and 325. In other aspects, the reference object used at block 325 is different from the reference object used at block 310. In such aspects, the reference object used at block 325 is set to the temperature of the FPA 104 when the second set of images are captured and the reference object used at block 310 is at around the room-ambient temperature when the first set of images are captured.

At block 330, the processor 122 determines SFFC values based on the first set of images and the second set of images. The SFFC values may be stored (e.g., in the memory 124 and/or other memory of and/or accessible to the infrared camera 100) and/or further processed. The SFFC values may be provided as (e.g., stored as) an SFFC map. In some aspects, the SFFC values may be based on a difference between the first and second set of images. When the first set of images and/or second set of images includes multiple images, the processor 122 may determine an average of a set of images to obtain an average image. For a given set of images, a value of each pixel of the average image may be obtained by averaging over values of the same pixel in the set of images. For example, when the first set of images and the second set of images include a first sequence of images and a second sequence of images, respectively, the processor 122 may determine a temporal average of the first sequence and a temporal average of the second sequence and subtract the temporal average of the second sequence from the temporal average of the first sequence to obtain the difference between the first and second set of images. In some cases, when determining an average image, one or more pixel values of one or more images of the sequence may be ignored when the pixel value(s) is considered an outlier (e.g., falls outside a range of values) when compared to the same pixels of the other images. In an aspect, the difference between the first and second set of images is, or is indicative of, a difference between a nearly-zero out-of-field irradiance condition and a steady-state out-of-field irradiance condition.

In some embodiments, capturing of the second set of images while a reference object (e.g., a thermal black body) is at or at approximately the same temperature as the FPA 104 allows for minimizing (e.g., reducing or avoiding) an in-field signal/component (e.g., an influence of an in-field signal/component) on the SFFC values (e.g., by essentially removing a pedestal caused by an in-field signal/component) at steady state compared to conventional approaches in which images of a black body at room-ambient temperature is captured after a camera has reached steady state. In this regard, in some aspects, the SFFC values determined according to various embodiments herein may be associated with reduced radiometric error (e.g., via a reduced or eliminated in-field signal) relative to SFFC values determined if the second set of images are captured by the FPA 104 while the reference object that subtends the infrared camera 100 is at a room ambient temperature. As such, the SFFC values determined according to various embodiments herein may be a closer representation of exclusively an out-of-field signal/component at steady state (e.g., substantially devoid of any in-field signal/component) compared to conventional approaches.

The SFFC values, such as those determined by performing the process 200 or 300, may be provided as (e.g., stored as) an SFFC map. In this regard, an SFFC map be a data structure that includes the SFFC values. The SFFC values/map may be applied to images. The SFFC values may be, may be considered, and/or may be derived from the difference between the first and second set of images. In some cases, the difference may be processed to obtain the SFFC values. As an example, the processor 122 may optionally apply smoothing to the difference (e.g., to minimize high-frequency noise in previously acquired image data). Such smoothing may utilize kernel smoothing techniques, high frequency noise suppression techniques, pixel value blurring techniques, and/or other appropriate techniques as known to one skilled in the art. For example, kernel smoothing may be applied using any desired density and/or repeated any desired number of times. In some cases, the processor 122 may scale the difference values or the smoothed difference values to a N-bit resolution corresponding to a range between −2^{N}+1 to +2^{N} to obtain the SFFC values (e.g., for storing, applying to image data, and/or further processing). As examples, SFFC values scaled to an eight-bit resolution may have values in the range between −127 and 128 (e.g., using seven data bits and one sign bit) and SFFC values scaled to a fifteen-bit resolution may have values in the range between −16,383 and 16,384 (e.g., using fourteen data bits and one sign bit). The value of N may be selected dependent on application to allow efficient usage of memory (e.g., the memory 124) during processing while providing sufficient resolution to mitigate non-uniformities that may be present in image data captured by the FPA 104. In some cases, rather than processing the difference between the first and second set of images, such processing may be performed on the first and second set of images and then a difference determined between the processed first set of images and the processed second set of images to determine the SFFC values.

In some embodiments, different sets of SFFC values may be determined and stored. Calibration may be performed by a manufacturer (e.g., factory calibration) or a user (e.g., in-the-field calibration) of the infrared camera 100 to determine one or more sets of SFFC values. Each set of SFFC values may be associated with a different configuration of the infrared camera 100, such as a different optics block (e.g., arrangement of one or more optical elements) in the optical path 150, enclosure/housing, mounting hardware, and/or other components of the infrared camera 100. For example, the user may perform a calibration of the infrared camera 100 to determine a new/updated set of SFFC values if the user replaces a lens of the optics block 116 with another lens. The new set of SFFC values associated with a new/current configuration of the optics block 116 may overwrite the previous set of SFFC values associated with a previous configuration of the optics block 116 or may be stored separately from the previous set of SFFC values (e.g., the previous set of SFFC values may continue to be stored and retrieved, such as if the current configuration of the optics block 116 is reverted back to the previous configuration).

The SFFC values determined at block 230 and/or block 330 may be applied to subsequent images captured by the FPA 104 (e.g., images not captured for the purpose of calibration to determine SFFC values). In some aspects, the SFFC values may be further processed and then applied to images. As an example, a scale factor (e.g., also referred to as a scale term) may be determined (e.g., by the processor 122) and applied to the SFFC values to obtain a scaled set of SFFC values, as further described herein. The scaled set of SFFC values may be applied (e.g., by the processor 122) to images. In some cases, the scale factor may be based on captured image data, such as temperatures and/or temperature changes over time of one or more objects in the scene. Since the SFFC map determined according to embodiments herein may be substantially devoid of any in-field signal/component, and thus substantially devoid of a pedestal caused by an in-field signal/component, when the SFFC map is scaled during real-time operation, there is no pedestal that is also scaled. Scaling of an SFFC map having a pedestal may complicate radiometric processing. Examples of systems and methods for determining scale factors that may be applied to SFFC values, such as SFFC values generated according to various embodiments herein, are provided in U.S. Pat. No. 10,986,288 and U.S. Patent Application Publication No. 2022/0261964, which are incorporated herein by reference in their entireties.

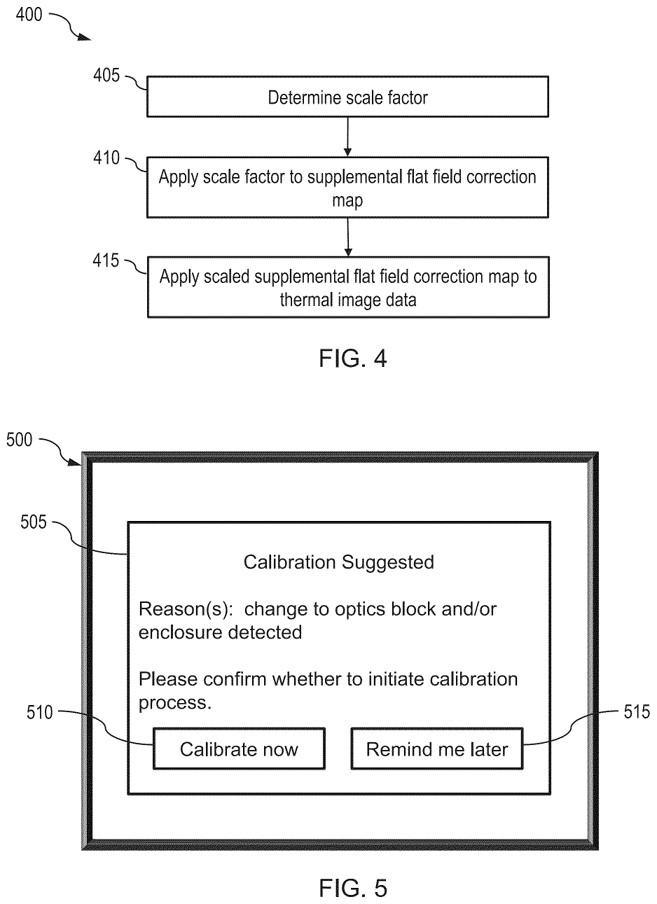

FIG. 4 illustrates a flow diagram of an example process 400 for applying SFFC values to captured image data in accordance with one or more embodiments of the present disclosure. Although the process 400 is primarily described herein with reference to the infrared camera 100 of FIG. 1 for explanatory purposes, the process 400 can be performed in relation to other systems for applying SFFC values. Note that one or more operations in FIG. 4 may be combined, omitted, and/or performed in a different order as desired.

At block 405, the processor 122 determines a scale factor/term to be applied to the SFFC map (e.g., the SFFC values of the SFFC map). The processor 122 may retrieve the SFFC map from the memory 124, other internal memory of the infrared camera 100, and/or memory external to the infrared camera 100. In some embodiments, the SFFC map may be generated by performing the process 200 or 300. In some cases, the scale factor may be adjusted/updated in real time or near real time, periodically, and/or upon user request. In some cases, the scale factor may be adjusted/updated in real time or near real time in response to changes in the temperature and/or rate of temperature change of one or more components (e.g., the FPA 104) of the infrared camera 100 (e.g., as measured by one or more temperature sensors).

At block 410, the processor 122 applies the scale factor to the SFFC map to obtain a scaled SFFC map. At block 415, the processor 122 applies the scaled FFC map to thermal image data. The thermal image data may be, or may be a processed version of, a thermal image captured by the FPA 104. The processor 122 may apply the scaled SFFC map to thermal image data in real time as a thermal image is captured by the FPA 104 or to thermal image data associated with a thermal image previously captured by the FPA 104 and stored for later retrieval/processing. It is noted that in some applications no scale factor is determined/applied. In this regard, with reference to the process 400, the scale factor may be considered to be set to one such that the SFFC map (e.g., determined by the process 200, the process 300, or other process) is directly applied to thermal image data.

In some embodiments, user interfaces may be presented to an operator (e.g., manufacturer and/or user) to facilitate the calibration of the infrared camera 100 (e.g., to determine SFFC values). In some cases, a user interface may provide a prompt suggesting or requiring that the operator perform calibration of the infrared camera 100. As an example, FIG. 5 illustrates an example display screen 500 with a dialog box 505 displayed thereon for facilitating calibration of the infrared camera 100 in accordance with one or more embodiments of the present disclosure. The display screen 500 may be provided by a display device integrated as part of the infrared camera 100 and/or a display device separate from and communicatively coupled to the infrared camera 100. As shown in FIG. 5, the dialog box 505 provides text indicating a reason that calibration is suggested and asks whether the user would like to start calibration by interacting with an interface element 510 (i.e., “Calibrate now” button) or wait until a later time (e.g., a time of a reminder may be settable by the user) by interacting with an interface element 515 (i.e., “Remind me later” button). Other non-limiting example reasons that calibration may be suggested may include an amount of time since a previous calibration exceeding a threshold time (e.g., set by the manufacturer or the user), a change in conditions (e.g., ambient temperature) in which the infrared camera 100 is operating, and/or a change to functionality parameters (e.g., changing a frame rate or a gain mode) by the user. The display screen 500 may allow user input (e.g., interaction with the dialog box 505) via a mouse (e.g., user input includes mouse movement and mouse click), a keyboard input, and/or a touch input for interacting with the interface elements 510 and 515.

While the dialog box 505 provides the user with an option to calibrate at a later time, in some applications, such as applications in which radiometric error needs to be minimized at all times and/or otherwise the infrared camera 100 is not allowed to be used when prior calibration results may be outdated, calibration may be required before the infrared camera 100 is able to be used to capture images in normal operation. The user may be provided with an option of when the infrared camera 100 begins calibration or may be provided with a countdown (e.g., a few seconds) before the infrared camera 100 automatically begins calibration unless manually postponed by the user. In some cases, alternative or in addition to a display screen with a graphical user interface window, the infrared camera 100 may have an indicator light (e.g., a flashing light emitting diode (LED) light) for indicating that a calibration is suggested or required (e.g., before the infrared camera 100 is able to be used to capture images in normal operation).

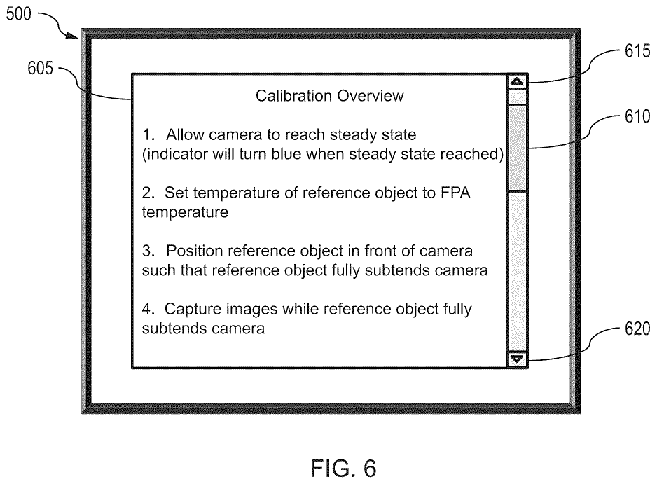

In some cases, a user interface may provide a user with an overview, instructions, and/or guidance for facilitating calibration. As an example, FIG. 6 illustrates the display screen 500 with a dialog box 605 displayed thereon for facilitating calibration of the infrared camera 100 in accordance with one or more embodiments of the present disclosure. The display screen 500 may be provided by a display device integrated as part of the infrared camera 100 and/or a display device separate from and communicatively coupled to the infrared camera 100. In one case, the display screen 500 may change from the dialog box 505 of FIG. 5 to the dialog box 605 of FIG. 6 when the interface element 510 (i.e., the “Calibrate now” button) in the dialog box 505 is selected. As shown in the dialog box 605, an overview of the steps associated with calibration is provided to the user. A slider 610, navigation buttons 615 and 620, a swipe gesture, a keyboard input, and/or others may be used to scroll up or down to see different portions of the calibration overview.

Alternative to or in addition to the overview shown in the dialog box 600, the display screen 500 may display one step at a time to the user and request that the user confirm whether the step has been performed before proceeding to a next step. As example, the display screen 500 may indicate to the user to “Set temperature of reference object to FPA temperature” and provide a button for the user to interact with to indicate once the user is done setting the reference object to the FPA temperature. After the user provides confirmation that the reference object has been set to the FPA temperature, the display screen 500 may proceed to the next step to indicate to the user where to position the reference object and provide a button for the user to interact with to indicate once the user is done positioning the reference object. After the user provides confirmation that the reference object has been properly positioned, the display screen 500 may proceed to the next step to indicate to the user that the infrared camera 100 will capture images and provide a button for the user to interact with to have the infrared camera 100 proceed to capture images (e.g., a predetermined number of images set by the manufacturer or the user).

Thus, using various embodiments, calibration may be performed for and by an infrared imaging system (e.g., the infrared camera 100) to generate SFFC values (e.g., an SFFC map) that are substantially exclusively represented by an out-of-field irradiance at steady state by minimizing an in-field signal/component. When an internal reference object/structure (e.g., shutter paddle) is used for the calibration, such as in the process 200, the in-field signal/component can be reduced or avoided by performing an external FFC operation and acquiring sets of images of a reference object at approximately the same temperature as the internal structure at steady-state condition. In a case that no shutter or other internal structure is used, such as in the process 300, the in-field signal/component can be reduced or avoided by acquiring, after steady state has been reached, a set of images of a reference object with the reference object at approximately the same temperature as the FPA at the time the images are acquired. Using such approaches reduces or avoids signals caused by in-field irradiance from the scene and thus essentially removes a pedestal caused by an in-field signal/component and provides an SFFC map that is a closer representation of just the out-of-field signal/component at steady state. The SFFC values generated according to various embodiments may better reduce or eliminate radiometric error, such as radiometric error caused by out-of-field irradiance, and thus mitigate non-uniformity caused by out-of-field irradiance. In cases that the SFFC map is scaled during real-time operation, there is no pedestal that is also scaled. Such a pedestal, if not eliminated or not at least reduced, may complicate radiometric processing.

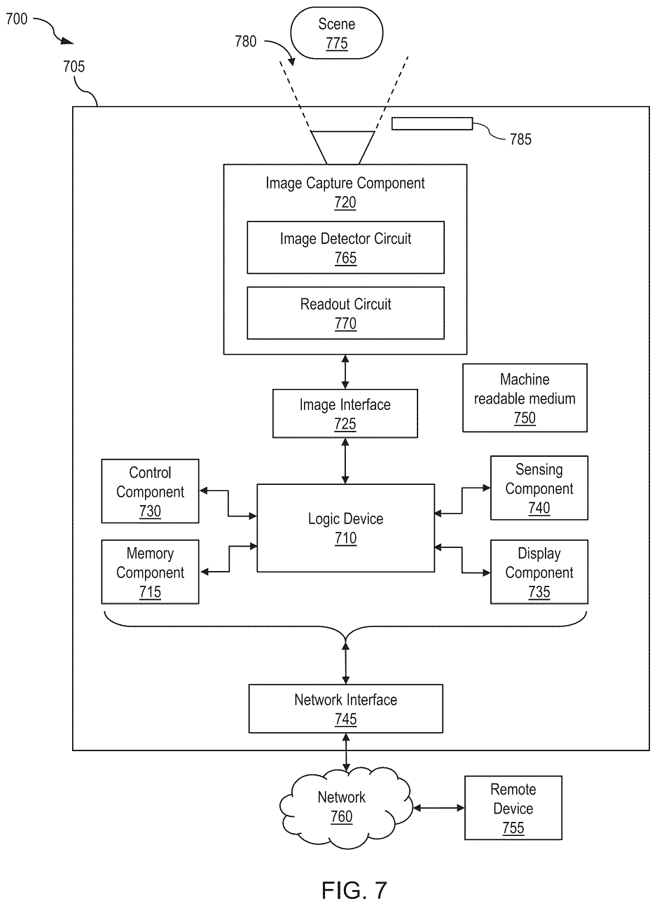

FIG. 7 illustrates a block diagram of an example imaging system 700 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. In an embodiment, the imaging system 700 may be, may include, or may be a part of the infrared camera 100 of FIG. 1.

The imaging system 700 may be utilized for capturing and processing images in accordance with an embodiment of the disclosure. The imaging system 700 may represent any type of imaging system that detects one or more ranges (e.g., wavebands) of EM radiation and provides representative data (e.g., one or more still image frames or video image frames). The imaging system 700 may include an imaging device 705. By way of non-limiting examples, the imaging device 705 may be, may include, or may be a part of an infrared camera (e.g., thermal infrared camera), a visible-light camera, a tablet computer, a laptop, a personal digital assistant (PDA), a mobile device, a desktop computer, or other electronic device. The imaging device 705 may include a housing (e.g., a camera body) that at least partially encloses components of the imaging device 705, such as to facilitate compactness and protection of the imaging device 705. For example, the solid box labeled 705 in FIG. 7 may represent a housing of the imaging device 705. The housing may contain more, fewer, and/or different components of the imaging device 705 than those depicted within the solid box in FIG. 7. In an embodiment, the imaging system 700 may include a portable device and may be incorporated, for example, into a vehicle or a non-mobile installation requiring images to be stored and/or displayed. The vehicle may be a land-based vehicle (e.g., automobile, truck), a naval-based vehicle, an aerial vehicle (e.g., unmanned aerial vehicle (UAV)), a space vehicle, or generally any type of vehicle that may incorporate (e.g., installed within, mounted thereon, etc.) the imaging system 700. In another example, the imaging system 700 may be coupled to various types of fixed locations (e.g., a home security mount, a campsite or outdoors mount, or other location) via one or more types of mounts.

The imaging device 705 includes, according to one implementation, a logic device 710 (e.g., also referred to as a processing component), a memory component 715, an image capture component 720 (e.g., an imager, an image sensor device), an image interface 725, a control component 730, a display component 735, a sensing component 740, and/or a network interface 745. The logic device 710, according to various embodiments, includes one or more of a processor, a microprocessor, a central processing unit (CPU), a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device, one or more memories for storing executable instructions (e.g., software, firmware, or other instructions), and/or or any other appropriate combination of processing device and/or memory to execute instructions to perform any of the various operations described herein. The logic device 710 may be configured, by hardwiring, executing software instructions, or a combination of both, to perform various operations discussed herein for embodiments of the disclosure. The logic device 710 may be configured to interface and communicate with the various other components (e.g., 715, 720, 725, 730, 735, 740, 745, etc.) of the imaging system 700 to perform such operations. For example, the logic device 710 may be configured to process captured image data received from the imaging capture component 720, store the image data in the memory component 715, and/or retrieve stored image data from the memory component 715. In one aspect, the logic device 710 may be configured to perform various system control operations (e.g., to control communications and operations of various components of the imaging system 700), calibration operations (e.g., the processes 200 and/or 300), and other image processing operations (e.g., the process 400, debayering, sharpening, color correction, offset correction, data conversion, data transformation, data compression, video analytics, etc.). In an embodiment, the logic device 710 may be, may include, or may be a part of, the processor 122.

The memory component 715 includes, in one embodiment, one or more memory devices configured to store data and information, including infrared image data and information. The memory component 715 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the logic device 710 may be configured to execute software instructions stored in the memory component 715 so as to perform method and process steps and/or operations. The logic device 710 and/or the image interface 725 may be configured to store in the memory component 715 images or digital image data captured by the image capture component 720. In one or more embodiments, such instructions, when executed by the logic device 710, may cause the imaging system 700 to perform operations to generate SFFC values (e.g., the processes 200 and/or 300) and apply the SFFC values (e.g., the process 400). In some embodiments, the memory component 715 may store various SFFC values from factory calibration and/or run-time/in-field calibration. In an embodiment, the memory component 715 may be, may include, or may be a part of, the memory 124.

In some embodiments, a separate machine-readable medium 750 (e.g., a memory, such as a hard drive, a compact disk, a digital video disk, or a flash memory) may store the software instructions and/or configuration data which can be executed or accessed by a computer (e.g., a logic device or processor-based system) to perform various methods and operations, such as methods and operations associated with processing image data. In one aspect, the machine-readable medium 750 may be portable and/or located separate from the imaging device 705, with the stored software instructions and/or data provided to the imaging device 705 by coupling the machine-readable medium 750 to the imaging device 705 and/or by the imaging device 705 downloading (e.g., via a wired link and/or a wireless link) from the machine-readable medium 750. It should be appreciated that various modules may be integrated in software and/or hardware as part of the logic device 710, with code (e.g., software or configuration data) for the modules stored, for example, in the memory component 715.

The imaging device 705 may be a video and/or still camera to capture and process images and/or videos of a scene 775. In this regard, the image capture component 720 of the imaging device 705 may be configured to capture images (e.g., still and/or video images) of the scene 775 in a particular spectrum or modality. In an embodiment, the image capture component 720 may be, may include, or may be a part of, the FPA 104. The image capture component 720 includes an image detector circuit 765 (e.g., a visible-light detector circuit, a thermal infrared detector circuit) and a readout circuit 770 (e.g., an ROIC). For example, the image capture component 720 may include an IR imaging sensor (e.g., IR imaging sensor array) configured to detect IR radiation in the near, middle, and/or far IR spectrum and provide IR images (e.g., IR image data or signal) representative of the IR radiation from the scene 775. For example, the image detector circuit 765 may capture (e.g., detect, sense) IR radiation with wavelengths in the range from around 700 nm to around 2 mm, or portion thereof. For example, in some aspects, the image detector circuit 765 may be sensitive to (e.g., better detect) SWIR radiation, mid-wave IR (MWIR) radiation (e.g., EM radiation with wavelength of 2 μm to 5 μm), and/or long-wave IR (LWIR) radiation (e.g., EM radiation with wavelength of 7 μm to 14 μm), or any desired IR wavelengths (e.g., generally in the 0.7 μm to 14 μm range). In other aspects, the image detector circuit 765 may capture radiation from one or more other wavebands of the EM spectrum, such as visible light, ultraviolet light, and so forth.

The image detector circuit 765 may capture image data (e.g., infrared image data) associated with the scene 775. To capture an image, the image detector circuit 765 may detect image data of the scene 775 (e.g., in the form of EM radiation) received through an aperture 780 of the imaging device 705 and generate pixel values of the image based on the scene 775. An image may be referred to as a frame or an image frame. In some cases, the image detector circuit 765 may include an array of detectors (e.g., also referred to as an array of pixels) that can detect radiation of a certain waveband, convert the detected radiation into electrical signals (e.g., voltages, currents, etc.), and generate the pixel values based on the electrical signals. Each detector in the array may capture a respective portion of the image data and generate a pixel value based on the respective portion captured by the detector. The pixel value generated by the detector may be referred to as an output of the detector. By way of non-limiting examples, each detector may be a photodetector, such as an avalanche photodiode, an infrared photodetector, a quantum well infrared photodetector, a microbolometer, or other detector capable of converting EM radiation (e.g., of a certain wavelength) to a pixel value. The array of detectors may be arranged in rows and columns.

The image may be, or may be considered, a data structure that includes pixels and is a representation of the image data associated with the scene 775, with each pixel having a pixel value that represents EM radiation emitted or reflected from a portion of the scene 775 and received by a detector that generates the pixel value. Based on context, a pixel may refer to a detector of the image detector circuit 765 that generates an associated pixel value or a pixel (e.g., pixel location, pixel coordinate) of the image formed from the generated pixel values. In an embodiment, the image may be a thermal infrared image (e.g., also referred to as a thermal image) based on thermal infrared image data. Each pixel value of the thermal infrared image represents a temperature of a corresponding portion of the scene 775.

In an aspect, the pixel values generated by the image detector circuit 765 may be represented in terms of digital count values generated based on the electrical signals obtained from converting the detected radiation. For example, in a case that the image detector circuit 765 includes or is otherwise coupled to an ADC circuit, the ADC circuit may generate digital count values based on the electrical signals. For an ADC circuit that can represent an electrical signal using 14 bits, the digital count value may range from 0 to 16,383. In such cases, the pixel value of the detector may be the digital count value output from the ADC circuit. In other cases (e.g., in cases without an ADC circuit), the pixel value may be analog in nature with a value that is, or is indicative of, the value of the electrical signal. As an example, for infrared imaging, a larger amount of IR radiation being incident on and detected by the image detector circuit 765 (e.g., an IR image detector circuit) is associated with higher digital count values and higher temperatures.

The readout circuit 770 may be utilized as an interface between the image detector circuit 765 that detects the image data and the logic device 710 that processes the detected image data as read out by the readout circuit 770, with communication of data from the readout circuit 770 to the logic device 710 facilitated by the image interface 725. An image capturing frame rate may refer to the rate (e.g., detector output images per second) at which images are detected/output in a sequence by the image detector circuit 765 and provided to the logic device 710 by the readout circuit 770. The readout circuit 770 may read out the pixel values generated by the image detector circuit 765 in accordance with an integration time (e.g., also referred to as an integration period).

In various embodiments, a combination of the image detector circuit 765 and the readout circuit 770 may be, may include, or may together provide an FPA (e.g., the FPA 104). In some aspects, the image detector circuit 765 may be a thermal image detector circuit that includes an array of microbolometers, and the combination of the image detector circuit 765 and the readout circuit 770 may be referred to as a microbolometer FPA. In some cases, the array of microbolometers may be arranged in rows and columns. The microbolometers may detect IR radiation and generate pixel values based on the detected IR radiation. For example, in some cases, the microbolometers may be thermal IR detectors that detect IR radiation in the form of heat energy and generate pixel values based on the amount of heat energy detected. The microbolometers may absorb incident IR radiation and produce a corresponding change in temperature in the microbolometers. The change in temperature is associated with a corresponding change in resistance of the microbolometers. With each microbolometer functioning as a pixel, a two-dimensional image or picture representation of the incident IR radiation can be generated by translating the changes in resistance of each microbolometer into a time-multiplexed electrical signal. The translation may be performed by the ROIC. The microbolometer FPA may include IR detecting materials such as amorphous silicon (a-Si), vanadium oxide (VOₓ), a combination thereof, and/or other detecting material(s). In an aspect, for a microbolometer FPA, the integration time may be, or may be indicative of, a time interval during which the microbolometers are biased. In this case, a longer integration time may be associated with higher gain of the IR signal, but not more IR radiation being collected. The IR radiation may be collected in the form of heat energy by the microbolometers.

In some cases, the image capture component 720 may include one or more optical components and/or one or more filters. The optical component(s) may include one or more windows, lenses, mirrors, beamsplitters, beam couplers, and/or other components to direct and/or focus radiation to the image detector circuit 765. The optical component(s) may include components each formed of material and appropriately arranged according to desired transmission characteristics, such as desired transmission wavelengths and/or ray transfer matrix characteristics. The filter(s) may be adapted to pass radiation of some wavelengths but substantially block radiation of other wavelengths. For example, the image capture component 720 may be an IR imaging device that includes one or more filters adapted to pass IR radiation of some wavelengths while substantially blocking IR radiation of other wavelengths (e.g., MWIR filters, thermal IR filters, and narrow-band filters). In this example, such filters may be utilized to tailor the image capture component 720 for increased sensitivity to a desired band of IR wavelengths. In an aspect, an IR imaging device may be referred to as a thermal imaging device when the IR imaging device is tailored for capturing thermal IR images. Other imaging devices, including IR imaging devices tailored for capturing infrared IR images outside the thermal range, may be referred to as non-thermal imaging devices. In an embodiment, the optical component(s) and, in some cases, the filter(s), may form the optics block 116 or a portion thereof.

In one specific, not-limiting example, the image capture component 720 may include an IR imaging sensor having an FPA of detectors responsive to IR radiation including near infrared (NIR), SWIR, MWIR, LWIR, and/or very-long wave IR (VLWIR) radiation. In some other embodiments, alternatively or in addition, the image capture component 720 may include a complementary metal oxide semiconductor (CMOS) sensor or a charge-coupled device (CCD) sensor that can be found in any consumer camera (e.g., visible light camera).

In some embodiments, the imaging system 700 includes a shutter 785. The shutter 785 may be operated to selectively inserted into an optical path between the scene 775 and the image capture component 720 to expose or block the aperture 780. Although the shutter 785 is shown as an internal shutter (e.g., a shutter within the housing of the imaging device 705), the shutter 785 may be positioned outside of the housing. In some cases, the shutter 785 may be movable into or outside of the housing. In other cases, the shutter 785 is designed to be positioned either only inside or only outside the housing. In some cases, the shutter 785 may be moved (e.g., slid, rotated, etc.) manually (e.g., by a user of the imaging system 700) and/or via an actuator (e.g., controllable by the logic device 710 in response to user input or autonomously, such as an autonomous decision by the logic device 710 to perform a calibration of the imaging device 705).

When the shutter 785 is outside of the optical path to expose the aperture 780, the electromagnetic radiation from the scene 775 may be received by the image detector circuit 765 (e.g., via one or more optical components and/or one or more filters). As such, the image detector circuit 765 captures images of the scene 775. The shutter 785 may be referred to as being in an open position or simply as being open. When the shutter 785 is inserted into the optical path to block the aperture 780, the electromagnetic radiation from the scene 775 is blocked from the image detector circuit 765. As such, the image detector circuit 765 captures images of the shutter 785. The shutter 785 may be referred to as being in a closed position or simply as being closed. In some cases, the shutter 785 may block the aperture 780 during a calibration process, in which the shutter 785 may be used as a uniform blackbody (e.g., a substantially uniform blackbody). For example, in some cases, a surface of the shutter 785 imaged by the image detector circuit 765 may be implemented by a uniform blackbody coating. In some cases, such as for an imaging device without a shutter or with a broken shutter or as an alternative to the shutter 785, a case or holster of the imaging device 705, a lens cap, a cover, a wall of a room, or other suitable object/surface may be used to provide a uniform blackbody (e.g., substantially uniform blackbody). In an embodiment, the shutter 785 may be the shutter 110.

Other imaging sensors that may be embodied in the image capture component 720 include a photonic mixer device (PMD) imaging sensor or other time of flight (ToF) imaging sensor, LIDAR imaging device, RADAR imaging device, millimeter imaging device, positron emission tomography (PET) scanner, single photon emission computed tomography (SPECT) scanner, ultrasonic imaging device, or other imaging devices operating in particular modalities and/or spectra. It is noted that for some of these imaging sensors that are configured to capture images in particular modalities and/or spectra (e.g., infrared spectrum, etc.), they are more prone to produce images with low frequency shading, for example, when compared with a typical CMOS-based or CCD-based imaging sensors or other imaging sensors, imaging scanners, or imaging devices of different modalities.

The images, or the digital image data corresponding to the images, provided by the image capture component 720 may be associated with respective image dimensions (also referred to as pixel dimensions). An image dimension, or pixel dimension, generally refers to the number of pixels in an image, which may be expressed, for example, in width multiplied by height for two-dimensional images or otherwise appropriate for relevant dimension or shape of the image. Thus, images having a native resolution may be resized to a smaller size (e.g., having smaller pixel dimensions) in order to, for example, reduce the cost of processing and analyzing the images. Filters (e.g., a non-uniformity estimate) may be generated based on an analysis of the resized images. The filters may then be resized to the native resolution and dimensions of the images, before being applied to the images.

The image interface 725 may include, in some embodiments, appropriate input ports, connectors, switches, and/or circuitry configured to interface with external devices (e.g., a remote device 755 and/or other devices) to receive images (e.g., digital image data) generated by or otherwise stored at the external devices. In an aspect, the image interface 725 may include a serial interface and telemetry line for providing metadata associated with image data. The received images or image data may be provided to the logic device 710. In this regard, the received images or image data may be converted into signals or data suitable for processing by the logic device 710. For example, in one embodiment, the image interface 725 may be configured to receive analog video data and convert it into suitable digital data to be provided to the logic device 710.

The image interface 725 may include various standard video ports, which may be connected to a video player, a video camera, or other devices capable of generating standard video signals, and may convert the received video signals into digital video/image data suitable for processing by the logic device 710. In some embodiments, the image interface 725 may also be configured to interface with and receive images (e.g., image data) from the image capture component 720. In other embodiments, the image capture component 720 may interface directly with the logic device 710.

The control component 730 includes, in one embodiment, a user input and/or an interface device, such as a rotatable knob (e.g., potentiometer), push buttons, slide bar, keyboard, and/or other devices, that is adapted to generate a user input control signal. The logic device 710 may be configured to sense control input signals from a user via the control component 730 and respond to any sensed control input signals received therefrom. The logic device 710 may be configured to interpret such a control input signal as a value, as generally understood by one skilled in the art. In one embodiment, the control component 730 may include a control unit (e.g., a wired or wireless handheld control unit) having push buttons adapted to interface with a user and receive user input control values. In one implementation, the push buttons and/or other input mechanisms of the control unit may be used to control various functions of the imaging device 705, such as calibration initiation and/or related control, shutter control, autofocus, menu enable and selection, field of view, brightness, contrast, noise filtering, image enhancement, and/or various other features.

The display component 735 includes, in one embodiment, an image display device (e.g., a liquid crystal display (LCD)) or various other types of generally known video displays or monitors. The logic device 710 may be configured to display image data and information on the display component 735. The logic device 710 may be configured to retrieve image data and information from the memory component 715 and display any retrieved image data and information on the display component 735. The display component 735 may include display circuitry, which may be utilized by the logic device 710 to display image data and information. The display component 735 may be adapted to receive image data and information directly from the image capture component 720, logic device 710, and/or image interface 725, or the image data and information may be transferred from the memory component 715 via the logic device 710. In some cases, user interfaces may be presented via the display component 735 to facilitate calibration of the imaging system 700 (e.g., one or more components of the imaging system 700). In some aspects, the control component 730 may be implemented as part of the display component 735. For example, a touchscreen of the imaging device 705 may provide both the control component 730 (e.g., for receiving user input via taps and/or other gestures) and the display component 735 of the imaging device 705. In an embodiment, the display screen 500 of FIGS. 5 and 6 may be implemented by the display component 735 and/or interaction with the display screen 500 may be implemented by the control component 730.

The sensing component 740 includes, in one embodiment, one or more sensors of various types, depending on the application or implementation requirements, as would be understood by one skilled in the art. Sensors of the sensing component 740 provide data and/or information to at least the logic device 710. In one aspect, the logic device 710 may be configured to communicate with the sensing component 740. In various implementations, the sensing component 740 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder or time-of-flight camera), and/or whether a tunnel or other type of enclosure has been entered or exited. The sensing component 740 may represent conventional sensors as generally known by one skilled in the art for monitoring various conditions (e.g., environmental conditions) that may have an effect (e.g., on the image appearance) on the image data provided by the image capture component 720.

In some implementations, the sensing component 740 (e.g., one or more sensors) may include devices that relay information to the logic device 710 via wired and/or wireless communication. For example, the sensing component 740 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, the logic device 710 can use the information (e.g., sensing data) retrieved from the sensing component 740 to modify a configuration of the image capture component 720 (e.g., adjusting a light sensitivity level, adjusting a direction or angle of the image capture component 720, adjusting an aperture, etc.).

In an embodiment, the sensing component 740 may be or may include the temperature sensor(s) 128 of FIG. 1. The sensing component 740 may include a temperature sensing component to provide temperature data (e.g., one or more measured temperature values) various components of the imaging device 705, such as the image detector circuit 765 and/or the shutter 785. By way of non-limiting examples, a temperature sensor may include a thermistor, thermocouple, thermopile, pyrometer, and/or other appropriate sensor for providing temperature data.

In some embodiments, various components of the imaging system 700 may be distributed and in communication with one another over a network 760. In this regard, the imaging device 705 may include a network interface 745 configured to facilitate wired and/or wireless communication among various components of the imaging system 700 over the network 760. In such embodiments, components may also be replicated if desired for particular applications of the imaging system 700. That is, components configured for same or similar operations may be distributed over a network. Further, all or part of any one of the various components may be implemented using appropriate components of the remote device 755 (e.g., a conventional digital video recorder (DVR), a computer configured for image processing, and/or other device) in communication with various components of the imaging system 700 via the network interface 745 over the network 760, if desired. Thus, for example, all or part of the logic device 710, all or part of the memory component 715, and/or all of part of the display component 735 may be implemented or replicated at the remote device 755. In some embodiments, the imaging system 700 may not include imaging sensors (e.g., image capture component 720), but instead receive images or image data from imaging sensors located separately and remotely from the logic device 710 and/or other components of the imaging system 700. It will be appreciated that many other combinations of distributed implementations of the imaging system 700 are possible, without departing from the scope and spirit of the disclosure.

Furthermore, in various embodiments, various components of the imaging system 700 may be combined and/or implemented or not, as desired or depending on the application or requirements. In one example, the logic device 710 may be combined with the memory component 715, image capture component 720, image interface 725, display component 735, sensing component 740, and/or network interface 745. In another example, the logic device 710 may be combined with the image capture component 720, such that certain functions of the logic device 710 are performed by circuitry (e.g., a processor, a microprocessor, a logic device, a microcontroller, etc.) within the image capture component 720.

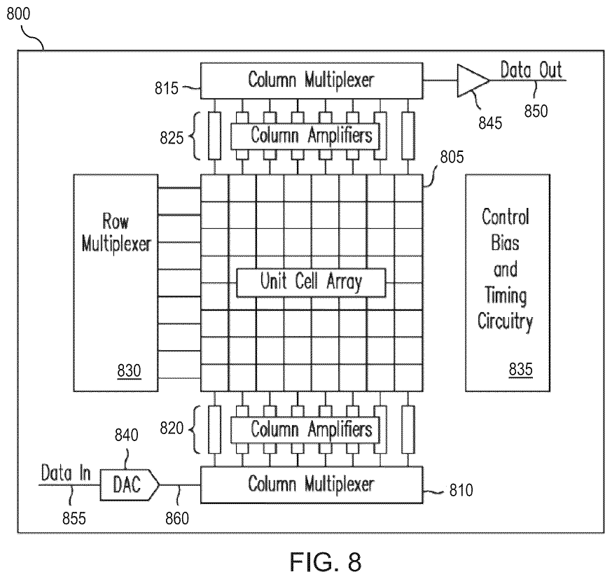

FIG. 8 illustrates a block diagram of an example image sensor assembly 800 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. In an embodiment, the image sensor assembly 800 may be an FPA, for example, implemented as the FPA 104 of FIG. 1 and/or the image capture component 720 of FIG. 7.

The image sensor assembly 800 includes a unit cell array 805, column multiplexers 810 and 815, column amplifiers 820 and 825, a row multiplexer 830, control bias and timing circuitry 835, a digital-to-analog converter (DAC) 840, and a data output buffer 845. In some aspects, operations of and/or pertaining to the unit cell array 805 and other components may be performed according to a system clock and/or synchronization signals (e.g., line synchronization (LSYNC) signals). The unit cell array 805 includes an array of unit cells. In an aspect, each unit cell may include a detector (e.g., a pixel) and interface circuitry. The interface circuitry of each unit cell may provide an output signal, such as an output voltage or an output current, in response to a detection signal (e.g., detection current, detection voltage) provided by the detector of the unit cell. The output signal may be indicative of the magnitude of EM radiation received by the detector and may be referred to as image pixel data or simply image data. The column multiplexer 815, column amplifiers 820, row multiplexer 830, and data output buffer 845 may be used to provide the output signals from the unit cell array 805 as a data output signal on a data output line 850. The output signals on the data output line 850 may be provided to components downstream of the image sensor assembly 800, such as processing circuitry (e.g., the logic device 710 of FIG. 7), memory (e.g., the memory component 715 of FIG. 7), display device (e.g., the display component 735 of FIG. 7), and/or other component to facilitate processing, storage, and/or display of the output signals. The data output signal may be an image formed of the pixel values for the image sensor assembly 800. In this regard, the column multiplexer 815, the column amplifiers 820, the row multiplexer 830, and the data output buffer 845 may collectively provide an ROIC (or portion thereof) of the image sensor assembly 800. In an aspect, the interface circuitry may be considered part of the ROIC, or may be considered an interface between the detectors and the ROIC. In some embodiments, components of the image sensor assembly 800 may be implemented such that the unit cell array 805 and the ROIC may be part of a single die.

The column amplifiers 825 may generally represent any column processing circuitry as appropriate for a given application (analog and/or digital), and is not limited to amplifier circuitry for analog signals. In this regard, the column amplifiers 825 may more generally be referred to as column processors in such an aspect. Signals received by the column amplifiers 825, such as analog signals on an analog bus and/or digital signals on a digital bus, may be processed according to the analog or digital nature of the signal. As an example, the column amplifiers 825 may include circuitry for processing digital signals. As another example, the column amplifiers 825 may be a path (e.g., no processing) through which digital signals from the unit cell array 805 traverses to get to the column multiplexer 815. As another example, the column amplifiers 825 may include an ADC for converting analog signals to digital signals (e.g., to obtain digital count values). These digital signals may be provided to the column multiplexer 815.

Each unit cell may receive a bias signal (e.g., bias voltage, bias current) to bias the detector of the unit cell to compensate for different response characteristics of the unit cell attributable to, for example, variations in temperature, manufacturing variances, and/or other factors. For example, the control bias and timing circuitry 835 may generate the bias signals and provide them to the unit cells. By providing appropriate bias signals to each unit cell, the unit cell array 805 may be effectively calibrated to provide accurate image data in response to light (e.g., visible-light, IR light) incident on the detectors of the unit cells. In an aspect, the control bias and timing circuitry 835 may be, may include, or may be a part of, a logic circuit, such as a part of the logic device 710.

The control bias and timing circuitry 835 may generate control signals for addressing the unit cell array 805 to allow access to and readout of image data from an addressed portion of the unit cell array 805. The unit cell array 805 may be addressed to access and readout image data from the unit cell array 805 row by row, although in other implementations the unit cell array 805 may be addressed column by column or via other manners.

The control bias and timing circuitry 835 may generate bias values and timing control voltages. In some cases, the DAC 840 may convert the bias values received as, or as part of, data input signal on a data input signal line 855 into bias signals (e.g., analog signals on analog signal line(s) 860) that may be provided to individual unit cells through the operation of the column multiplexer 810, column amplifiers 820, and row multiplexer 830. For example, the DAC 840 may drive digital control signals (e.g., provided as bits) to appropriate analog signal levels for the unit cells. In some technologies, a digital control signal of 0 or 1 may be driven to an appropriate logic low voltage level or an appropriate logic high voltage level, respectively. In another aspect, the control bias and timing circuitry 835 may generate the bias signals (e.g., analog signals) and provide the bias signals to the unit cells without utilizing the DAC 840. In this regard, some implementations do not include the DAC 840, data input signal line 855, and/or analog signal line(s) 860. In an embodiment, the control bias and timing circuitry 835 may be, may include, may be a part of, or may otherwise be coupled to the logic device 710 and/or image capture component 720 of FIG. 7.

In an embodiment, the image sensor assembly 800 may be implemented as part of an imaging device (e.g., the imaging device 705). In addition to the various components of the image sensor assembly 800, the imaging device may also include one or more processors, memories, logic, displays, interfaces, optics (e.g., lenses, mirrors, beamsplitters), and/or other components as may be appropriate in various implementations. In an aspect, the data output signal on the data output line 850 may be provided to the processors (not shown) for further processing. For example, the data output signal may be an image formed of the pixel values from the unit cells of the image sensor assembly 800. The processors may perform operations such as non-uniformity correction (e.g., flat-field correction or other calibration technique), spatial and/or temporal filtering, and/or other operations. The images (e.g., processed images) may be stored in memory (e.g., external to or local to the imaging system) and/or displayed on a display device (e.g., external to and/or integrated with the imaging system). The various components of FIG. 8 may be implemented on a single chip or multiple chips. Furthermore, while the various components are illustrated as a set of individual blocks, various of the blocks may be merged together or various blocks shown in FIG. 8 may be separated into separate blocks.

It is noted that in FIG. 8 the unit cell array 805 is depicted as an 8×8 (e.g., 8 rows and 8 columns of unit cells. However, the unit cell array 805 may be of other array sizes. By way of non-limiting examples, the unit cell array 805 may include 512×512 (e.g., 512 rows and 512 columns of unit cells), 1024×1024, 2048×2048, 4096×4096, 8192×8192, and/or other array sizes. In some cases, the array size may have a row size (e.g., number of detectors in a row) different from a column size (e.g., number of detectors in a column). Examples of frame rates may include 30 Hz, 60 Hz, and 120 Hz. In an aspect, each unit cell of the unit cell array 805 may represent a pixel.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A method comprising:
capturing, by a focal plane array (FPA) of an imaging system, a first set of images of a first reference object in a scene while the first reference object is at a temperature associated with a second reference object when capturing the first set of images;
capturing, by the FPA, a second set of images of the second reference object; and
determining supplemental flat field correction (SFFC) values based on the first set of images and the second set of images.

2. The method of claim 1, further comprising:
determining a first average image based on the first set of images;
determining a second average image based on the second set of images; and
determining a difference based on the first average image and the second average image, wherein the SFFC values are based on the difference.

3. The method of claim 1, further comprising:
capturing, by the FPA, an image; and
generating a corrected image based on the SFFC values and the image.

4. The method of claim 3, further comprising:
determining a scale factor associated with the image; and
generating a scaled SFFC map by applying the scale factor to the SFFC values, wherein the corrected image is based on the scaled SFFC map and the image.

5. The method of claim 1, further comprising:
monitoring one or more temperature characteristics associated with a component of the imaging system after power on of at least a portion of the imaging system; and
determining whether the portion of the imaging system has reached steady state based at least on the one or more temperature characteristics,
wherein the capturing the first set of images and the capturing the second set of images are performed after the portion of the imaging system is determined to have reached steady state.

6. The method of claim 5, wherein the component comprises the FPA, wherein the one or more temperature characteristics comprises a temperature of the FPA and/or a rate of temperature change of the FPA, and wherein the capturing the second set of images comprises capturing the second set of images while the first reference object is at the temperature associated with the second reference object when capturing the second set of images.

7. The method of claim 1, further comprising storing the SFFC values in a memory device of the imaging system, wherein the first set of images is associated with FFC values associated with an optical path from the scene to the FPA, wherein the second set of images is associated with FFC values associated with an optical path from the second reference object to the FPA, and wherein the SFFC values are associated with reduced radiometric error relative to SFFC values determined if the first and/or second set of images are captured while the first reference object is at a room ambient temperature.

8. The method of claim 1, wherein the second reference object comprises an internal structure of the imaging system, and wherein the internal structure is selectively positioned between the FPA and the scene.

9. The method of claim 8, wherein the internal structure comprises a shutter of the imaging system.

10. An imaging system comprising:
a focal plane array (FPA) configured to:
capture a first set of images of a first reference object in a scene while the first reference object is at a temperature associated with a second reference object when capturing the first set of images; and
capture a second set of images of the second reference object; and
a logic device configured to determine supplemental flat field correction (SFFC) values based on the first set of images and the second set of images.

11. The imaging system of claim 10, wherein the logic device is configured to determine a difference based on the first set of images and the second set of images, wherein the SFFC values are based on the difference, wherein the second reference object is a shutter, and wherein the imaging system further comprises the shutter.

12. The imaging system of claim 10, wherein:
the FPA is further configured to capture an image;
the FPA comprises a plurality of microbolometers; and
the logic device is further configured to generate a corrected image based on the SFFC values and the image.

13. The imaging system of claim 10, wherein the logic device is further configured to:
receive one or more temperature characteristics associated with a component of the imaging system after power on of at least a portion of the imaging system; and
determine whether the portion of the imaging system has reached steady state based at least on the one or more temperature characteristics,
wherein the logic device is configured to capture the first set of images and the second set of images after the portion of the imaging system is determined to have reached steady state.

14. The imaging system of claim 13, further comprising:
a memory device configured to store the SFFC values; and
a temperature sensor configured to determine the one or more temperature characteristics and transmit the one or more temperature characteristics to the logic device, wherein the SFFC values are associated with reduced radiometric error relative to SFFC values determined if the first and/or second set of images are captured by the FPA while the first reference object is at a room ambient temperature.

15. A method comprising:
capturing, by a focal plane array (FPA) of an imaging system, a first set of images of a first reference object in a scene;
capturing, by the FPA, a second set of images of a second reference object while the second reference object is at a temperature associated with the FPA when capturing the second set of images; and
determining supplemental flat field correction (SFFC) values based on the first set of images and the second set of images.

16. The method of claim 15, further comprising:
determining a first average image based on the first set of images;
determining a second average image based on the second set of images; and
determining a difference based on the first average image and the second average image, wherein the SFFC values are based on the difference, and wherein the capturing the first set of images is performed immediately after power on of the imaging system.

17. The method of claim 15, further comprising:
capturing, by the FPA, an image;
determining a scale factor associated with the image;
generating a scaled SFFC map by applying the scale factor to the SFFC values; and
generating a corrected image based on the scaled SFFC map and the image, wherein the SFFC values are associated with reduced radiometric error relative to SFFC values determined if the second set of images are captured by the FPA while the first reference object is at a room ambient temperature.

18. The method of claim 15, wherein the capturing the first set of images is performed while the first reference object is at a room ambient temperature.

19. The method of claim 15, further comprising:
monitoring one or more temperature characteristics associated with a component of the imaging system after power on of at least a portion of the imaging system; and
determining whether the portion of the imaging system has reached steady state based at least on the one or more temperature characteristics,
wherein the capturing the first set of images is performed before the portion of the imaging system is determined to have reached steady state and the capturing the second set of images is performed after the portion of the imaging system is determined to have reached steady state.

20. The method of claim 19, wherein the first reference object is the second reference object, wherein the component comprises the FPA, and wherein the one or more temperature characteristics comprises a temperature of the FPA and/or a rate of temperature change of the FPA.
